(19) United States
(12) Patent Application Publication
(10) Pub. No.: US 2019/0043466 A1
(43) Pub. Date: Feb. 7, 2019

(54) ACTIVE LISTENING PRIVACY DEVICE AND METHOD

(71) Applicant: CONE OF SILENCE LLC, RICHMOND, VA (US)

(72) Inventors: BRUCE MASTERSON, RIVERWOODS, IL (US); STANISLAV TODROMOVICH, RICHMOND, VA (US); JORDAN MORAN, HENRICO, VA (US); JOSEPH B. NIEMANN, MIDLOTHIAN, VA (US); BRUCE SEYMOUR FERRIS, RICHMOND, VA (US); PAUL G. ROCKWELL, MIDLOTHIAN, VA (US); BRIAN J. TEAGUE, MECHANICSVILLE, VA (US)

(21) Appl. No.: 15/977,245

(22) Filed: May 11, 2018

Related U.S. Application Data
(60) Provisional application No. 62/541,381, filed on Aug. 4, 2017.

(51) Int. Cl. G10K 11/175; H04R 1/02; H04R 1/40

(52) U.S. Cl. CPC G10K 11/175; H04R 1/406; H04R 1/025

(57) ABSTRACT

A sound masking device comprises a housing having an open end, a white noise generator within the housing, and a speaker to receive a white noise signal from the white noise generator and to emit a white noise corresponding to the white noise signal. The speaker is set back from the open end and positioned within the housing to emit the white noise toward the open end. The housing may comprise a shelf or shoulder around an inner surface of the housing located between the speaker and the open end.

### CROSS-REFERENCE TO RELATED APPLICATIONS

This application claims priority to U.S. Provisional Application Ser. No. 62/541,381, filed Aug. 8, 2017, the contents of which are incorporated herein by reference in its entirety.

### FIELD OF THE INVENTION

The present invention relates generally to sound masking devices.

### BACKGROUND

Active listening devices (ALDs) and voice-activated personal digital assistants (such as Amazon Echo/Dot, Google Home, Apple Siri, and the like) are popular and being used in more and more homes. However, personal privacy has become a major concern to many consumers who may be reluctant to use such an ALD. On one hand, these devices provide convenient assistance and entertainment. On the other hand, when not in use, these devices are capable of recording and transmitting everything that they hear through the internet. Though this is not their intended use, it could happen and this is a problem.

### BRIEF SUMMARY OF THE DISCLOSURE

In one embodiment of the invention, a sound masking device comprises a housing having an open end, a white noise generator within the housing, and a speaker to receive a white noise signal from the white noise generator and to emit a white noise corresponding to the white noise signal. The speaker is set back from the open end and positioned within the housing to emit the white noise toward the open end.

The open end may be adapted to receive an upper portion of an active listening device such that the upper portion of the active listening device contacts an inner surface of the housing located between the speaker and the open end to create a closed acoustical chamber between the upper portion of the active listening device and the speaker.

The open end may be adapted to receive an upper portion of an active listening device such that the upper portion of the active listening device contacts an inner surface of the housing located between the speaker and the open end to block the white noise from escaping between the upper portion of the active listening device and the inner surface of the housing located between the speaker and the open end.

An inner surface of the housing may be located between the speaker and the open end comprises a first angled portion that is angled outward toward the open end. The inner surface of the housing located between the speaker and the open end may further comprise a second angled portion that is angled toward the open end, and a diameter of the first angled portion may be smaller than a diameter of the second angled portion.

At least a portion of an inner surface of the housing located between the speaker and the open end may have an elastomeric surface or an elastomeric projection therefrom. The elastomeric projection may comprise a wiping seal.

The housing may comprise a shelf or shoulder around an inner surface of the housing located between the speaker and the open end.

The shelf or shoulder may be a first shelf or shoulder having a diameter. The housing may further comprise a second shelf or shoulder around an inner surface of the housing located between the first shelf or shoulder and the open end, the second shelf or shoulder having a diameter. The diameter of the first shelf or shoulder is smaller than the diameter of the second shelf or shoulder.

The housing may comprise an inner housing portion and an outer housing portion. The outer housing portion forms a sleeve around the inner housing portion and forms a collar extending beyond an end of the inner housing portion. The collar defines the open end of the housing. The speaker is within or affixed to the inner housing portion.

The outer housing portion may comprise a shelf or shoulder around an inner surface of the collar.

The outer housing portion may be a first outer housing portion. The device may further comprise a second outer housing portion. The first and second outer housing portions may be selectively interchangeably attachable to the inner housing portion. When the second outer housing portion is attached to the inner housing portion, the second outer housing portion (a) forms a sleeve around the inner housing portion, (b) forms a collar extending beyond an end of the inner housing portion, and(c) defines an open end of the housing.

The collar formed by the first outer housing portion may have a different size than the collar formed by the second outer housing portion. The collar formed by the first outer housing portion may have a different diameter than the collar formed by the second outer housing portion. The collar formed by the first outer housing portion may have a different shape than the collar formed by the second outer housing portion.

In alternative embodiments of the invention, a method of masking sound reaching a microphone of an active listening device comprises positioning a sound masking device on an active listening device such that a portion of the active listening device containing one or more microphones is inserted into an open end of a housing of the sound masking device, and activating the sound masking device such that a speaker within the housing of the sound masking device emits white noise toward the open end of the housing of the sound masking device and toward the portion of the active listening device containing one or more microphones.

The inserted portion of the active listening device may contact an inner surface of the housing located between the speaker and the open end to create a closed acoustical chamber between the inserted portion of the active listening device and the speaker.

The inserted portion of the active listening device may contact an inner surface of the housing located between the speaker and the open end to block the white noise from escaping between the inserted portion of the active listening device and the inner surface of the housing located between the speaker and the open end.

An inner surface of the housing located between the speaker and the open end may comprise a first angled portion that is angled outward toward the open end. The inner surface of the housing located between the speaker and the open end may further comprise a second angled portion that is angled toward the open end, and wherein a diameter of the first angled portion is smaller than a diameter of the second angled portion.

At least a portion of an inner surface of the housing located between the speaker and the open end may have an elastomeric surface or an elastomeric projection therefrom. The elastomeric projection may comprise a wiping seal.

The housing of the sound masking device may comprise a shelf or shoulder around an inner surface of the housing located between the speaker and the open end such that a portion of the active listening device contacts the shelf or shoulder when the sound masking device is positioned on the active listening device.

The shelf or shoulder may be a first shelf or shoulder having a diameter. The housing may further comprise a second shelf or shoulder around an inner surface of the housing located between the first shelf or shoulder and the open end, the second shelf or shoulder having a diameter. The diameter of the first shelf or shoulder is smaller than the diameter of the second shelf or shoulder. Depending on a size of the portion of the active listening device containing one or more microphones, a portion of the active listening device contacts either the first shelf or shoulder or the second shelf or shoulder when the sound masking device is positioned on the active listening device.

The outer housing portion may be a first outer housing portion. The device may further comprise a second outer housing portion. The first and second outer housing portions may be selectively interchangeably attachable to the inner housing portion. When the second outer housing portion is attached to the inner housing portion, the second outer housing portion (a) forms a sleeve around the inner housing portion, (b) forms a collar extending beyond an end of the inner housing portion, and(c) defines an open end of the housing. The method may further comprise selecting one of the first or second outer housing portions corresponding to a physical characteristic of the active listening device and attaching the selected outer housing portion to the inner housing portion.

The collar formed by the first outer housing portion may have a different size, diameter, or shape than the collar formed by the second outer housing portion. The physical characteristic of the active listening device may comprise, respectively, a size, diameter, or shape of the portion of the active listening device containing one or more microphones.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a perspective view of an active listening device that may be used with an active listening privacy device of embodiments of the present invention.

FIG. 2 is a top perspective view of an active listening privacy device, in accordance with embodiments of the present invention.

FIG. 3 is a bottom perspective view of the active listening privacy device of FIG. 2.

FIG. 4 is a perspective cross-sectional view of the active listening privacy device of FIG. 2 in place on an active listening device.

FIG. 5 is a front cross-sectional view of the active listening privacy device of FIG. 2 in place on an active listening device.

FIG. 6 is a hardware block diagram of an active listening privacy device, in accordance with embodiments of the present invention.

FIG. 7 is a state diagram of an active listening privacy device, in accordance with embodiments of the present invention.

FIG. 8 is a front cross-sectional view of an active listening privacy device, in accordance with alternative embodiments of the present invention.

FIG. 9 is a front cross-sectional view of an active listening privacy device, in accordance with alternative embodiments of the present invention.

FIG. 10 is a front cross-sectional view of an active listening privacy device, in accordance with alternative embodiments of the present invention.

FIG. 11 is a front cross-sectional view of an active listening privacy device, in accordance with alternative embodiments of the present invention.

FIG. 12 is a front cross-sectional view of an active listening privacy device, in accordance with alternative embodiments of the present invention.

FIG. 13 is a front cross-sectional view of an active listening privacy device, in accordance with alternative embodiments of the present invention.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the invention are directed to an Active Listening Privacy Device (ALPD) and associated method. An ALPD of embodiments of the invention is a low-voltage powered privacy device for increasing the privacy of a conversation within the listening range of an ALD. The ALPD generates a random signal that acoustically masks the microphone(s) in an ALD. An ALPD of embodiments of the invention may temporarily mask the microphone(s) in one or more of the ALDs by generating/playing, for example, either broadband white noise or a narrower bandwidth signal (such as a 300-8000 Hz signal) (or any other suitable masking signal) when activated and positioned correctly relative to the ALD requiring masking.

The ALPD must be placed in the correct position on the ALD as intended by the design of a specific ALPD, as described further below. Furthermore, the ALPD may come with and/or have adaptors available to fit onto multiple ALDs, as described further below, allowing a single ALPD to work effectively with various ALD brands/models. The structure of the ALPD and the adaptors will differ for various ALD brands/models based on the structure of the ALD (e.g., size and shape) and the placement of their microphone(s).

All ALDs have at least one microphone and, in most cases, like the Amazon® Echo® and Echo Dot®, contain microphone arrays that listen for trigger words and/or full audio spectrum recordings. The Echo Dot utilizes seven microphones. These microphones enable an ALD to record, store, process, and analyze audio. The ALDs also send the recorded audio periodically and on-demand upstream to the manufacturer for further processing and analysis via an Internet connection.

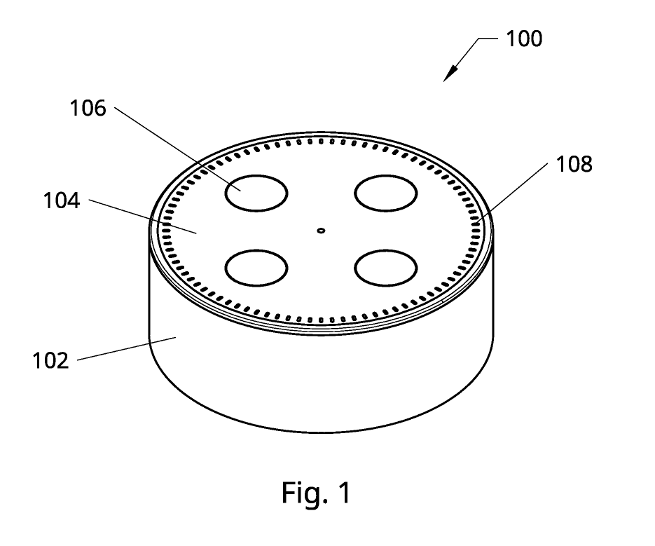

Referring now to the figures, wherein like numerals indicate like elements throughout, FIG. 1 illustrates an active listening device that may be used with an active listening privacy device of embodiments of the present invention. The illustrated ALD 100 is an Amazon Echo Dot, although embodiments of the invention can work with many different ALDs. The ALD 100 has a generally squat cylindrical shape provided by housing 102. The ALD will typically have a plurality of control buttons; in FIG. 1, the ALD 100 has four control buttons 106 built into the top surface 104 of the ALD. In the Echo Dot ALD, seven microphones (not visible) are arrayed around the edge of the top end, underneath the top surface 104. A plurality of holes 108 are defined around the edge of the top surface 104 to enable sound to reach the microphones.

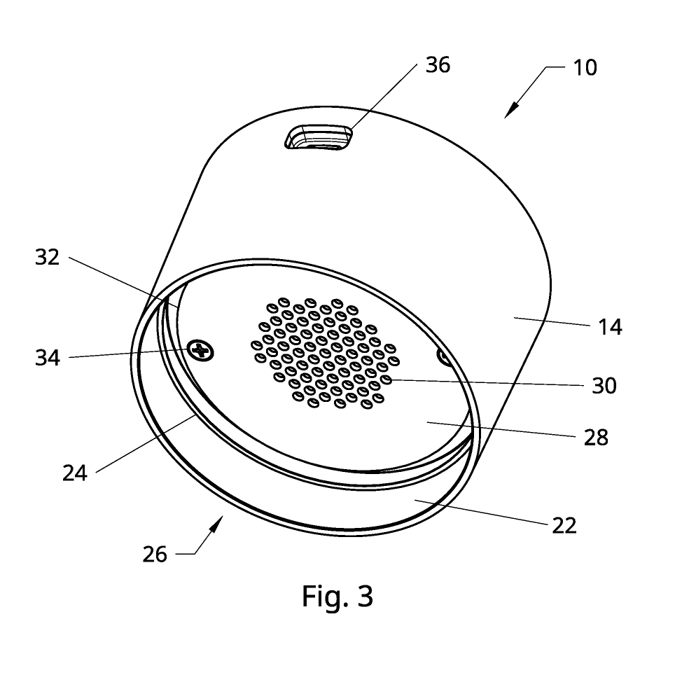

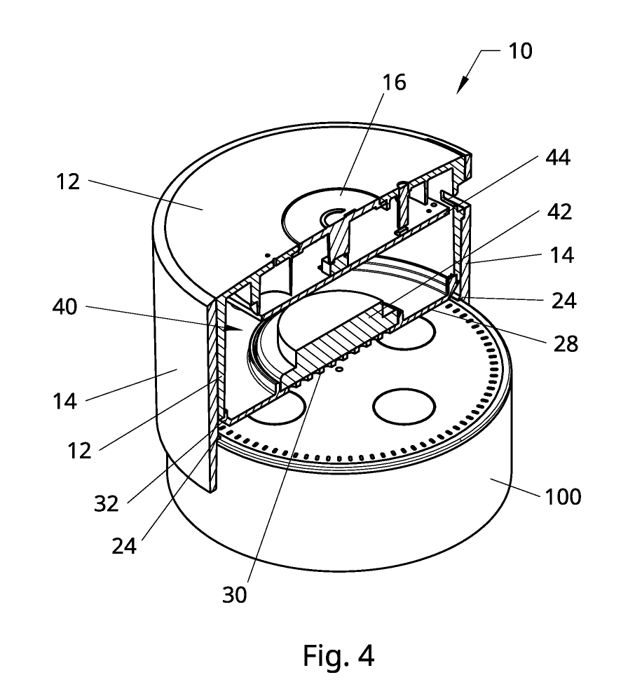

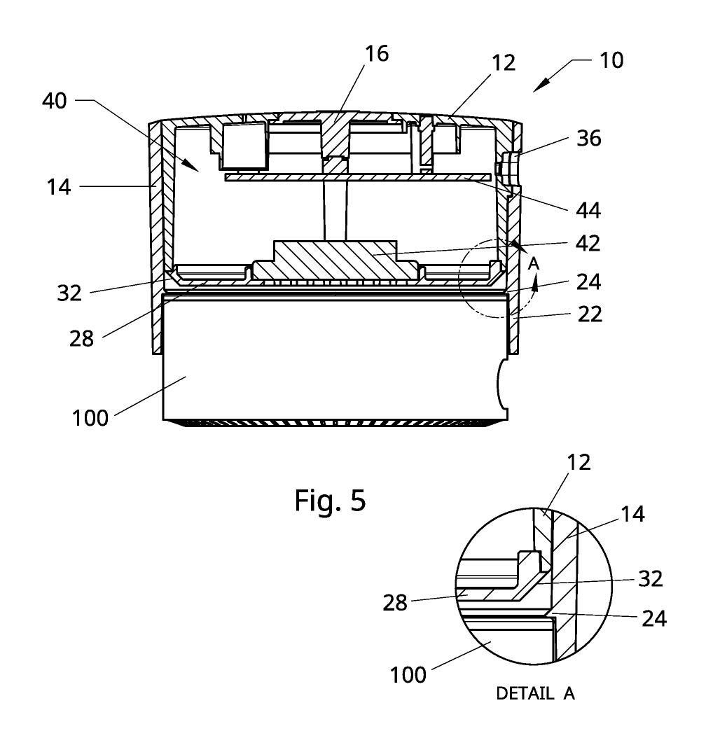

Referring now to FIGS. 3-5, an active listening privacy device (ALPD) 10 is illustrated in accordance with embodiments of the present invention. The ALPD 10 comprises a housing defining an open bottom end 26. (As described further below, the housing of the ALPD 10 comprises an inner housing portion 12 and an outer housing portion 14.) The open bottom end 26 is sized and shaped to receive a portion of the ALD 100 that contains the microphones (in the case of the Echo Dot ALD, that portion is the top end). In this regard, the ALPD 10 sits on top of the ALD 100 and covers or encloses the top end of the ALD 100 (and therefore the microphones), as seen in FIGS. 4 and 5. The open top end 26 is designed to fit relatively snugly around the top end of the ALD 100 to help ensure that the ALPD 10 remains in place.

In the illustrated embodiment of the ALPD 10, the housing has a generally cylindrical side wall and a generally planar top wall, although the shape of the top wall and (especially) the side wall may vary. Also in the illustrated embodiment of the ALPD 10, the top wall has a power button 16, and one or more indicator lights 20 (one is illustrated). The number, type, and placement of control buttons, switches, indicators, and the like may vary as desired. A USB port 36 (or any other suitable charging and/or communication port) is defined in the side wall.

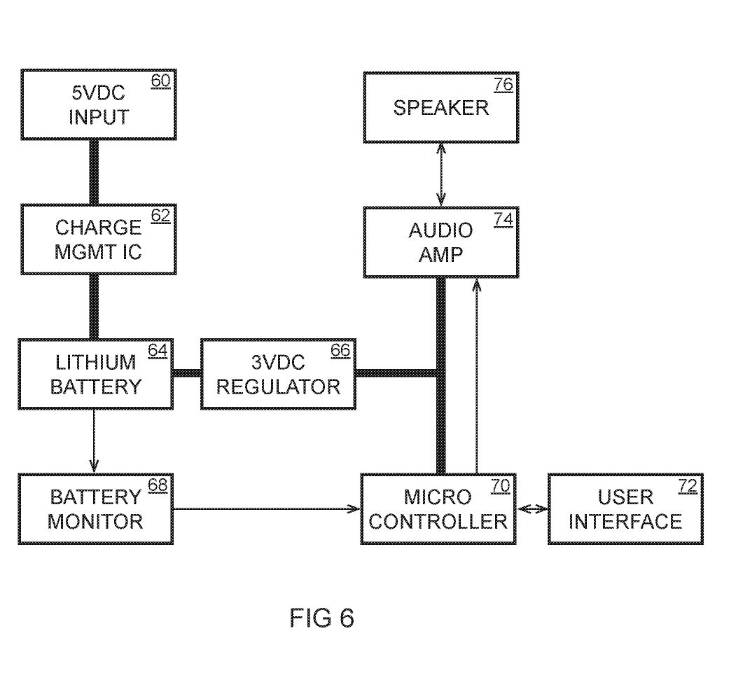

An internal chamber 40 is defined in the housing. The chamber 40 contains the various operational components of the ALPD 10 (such as a microcontroller, audio amplifier, battery and associated charging circuitry, etc.), some of which may be mounted on printed circuit board 44 and which are described further below in relation to FIG. 6. The placement of most components and the mounting structure within the chamber 40 may vary and are not illustrated.

A speaker 42 is set back from the open end 26 and positioned within the housing to emit white noise toward the open end 26 and therefore toward the microphones of the ALD 100 when the ALPD is mated to the ALD. A speaker cover 28 protects the speaker 42 and forms the bottom wall of the chamber 40. The speaker cover 28 is affixed to the housing using screws 34 or any other suitable mechanism. A plurality of holes 30 are defined in the speaker cover 28 in line with the speaker 42 to enable white noise from the speaker 42 to reach the microphones of the ALD 100. The outer edge 32 of the speaker cover 28 is angled or beveled such that the speaker cover 28 projects downward.

A white noise generator (which may be a microcontroller) is positioned within the housing. The speaker 42 receives a white noise signal from the white noise generator and emits white noise corresponding to the white noise signal. The speaker 42 may emit white noise at a volume of around 40 dB (the volume may vary depending on the exact structure of the ALPD and the ALD with which the ALPD is used, for example, the proximity of the speaker 42 to the ALD microphones). The volume may or may not be adjustable by a user. The process of generating the white noise is described further below.

The portion of the housing that projects downward beyond the speaker and that forms the open end 26 may be termed a collar 22. A shelf or shoulder 24 may be formed around an inner surface of the collar between the speaker 42 and the open end 26. The shelf/shoulder 24 engages the top surface of the ALD when the ALPD and the ALD are mated. The shelf/shoulder 24 maintains a desired spacing between the top surface of the ALD and the speaker cover 28. While the exact spacing between the top surface of the ALD and the speaker cover 28 is typically not important, it is generally desirable to maintain at least a small amount of spacing to keep the top surface of the ALD from contacting (and possibly damaging) the speaker cover 28 and underlying speaker 42. The shelf/shoulder 24 may be continuous around the entire inner circumference of the collar 22, as illustrated, or the shelf/shoulder may comprise a plurality of discrete (non-continuous) protrusions. In alternative embodiments, such a shelf/shoulder (continuous or discrete protrusions) may project downward from a different portion of the housing (and possibly from the speaker cover), rather than projecting inward from the collar. The shelf/shoulder 24 illustrated in FIGS. 3-5 is fairly small, but may be larger in alternative embodiments.

The housing of the ALPD may comprise a single, unitary housing forming the side wall, top wall, chamber, and collar. However, in the illustrated embodiment a two-part housing is used. The housing of the ALPD 10 comprises an inner housing portion 12 and an outer housing portion 14. The inner housing portion 12 forms the top wall and the chamber 40. The outer housing portion 14 forms a sleeve around the inner housing portion 12 and forms the collar 22. The speaker cover 28 is affixed to the inner housing portion 12 and the speaker 42 is affixed to the speaker cover 28 (although the speaker could be affixed to some other structure of the inner housing portion). In the illustrated embodiment, the shelf/shoulder 24 is part of the outer housing portion 14. The purpose of such a two-part housing is described below. The unitary or two-part housing of the ALPD of embodiments of the invention is constructed from any suitable rigid, durable material, such as any suitable plastic or any suitable metal.

FIG. 6 is a hardware block diagram of an active listening privacy device of embodiments of the invention. In FIG. 6, the bold interconnecting lines illustrate the power architecture, while the thin interconnecting lines illustrate the signal paths and directions. The power architecture of FIG. 6 is for illustrative purposes, and not intended to be limiting, as other suitable power architectures may be used. The ALPD of embodiments of the invention typically is battery-powered and rechargeable. As such, the ALPD has a lithium battery 64 (or other suitable power source) for powering the components. The battery 64 may be recharged via a recharging cable (e.g., a USB cable plugged into USB port 36) providing a five VDC input 60. A conventional charge management integrated circuit (IC) 62 controls the charging of the battery 64. A battery monitory 68 communicates the battery status (such as voltage level) to a microcontroller 70. The microcontroller 70 may comprise a microprocessor, dedicated or general purpose circuitry (such as an application-specific integrated circuit or a field-programmable gate array), a suitably programmed computing device, or any other suitable means for controlling the operation of the device. The battery 64 provides power, via a three VDC regulator 66, to the microcontroller 70 and to an audio amplifier 74. The audio amplifier powers a speaker 76 (which corresponds to speaker 42 in FIGS. 4 and 5). The microcontroller 70 interfaces with user interface elements 72 to receive one or more inputs from a user and to provide one or more outputs to a user. User interface elements 72 may include, for example, power button 16 and indicator light 20 (many other and/or different types of user interface elements may be provided).

The white noise signal is generated by the microcontroller 70 and provided to the audio amplifier 74, which in turn powers the speaker 76 to emit white noise corresponding to the white noise signal. The white noise should generally cover or block the spectrum of sound captured by the ALD microphone(s). The ALD microphone(s) captures sounds in the voice spectrum which is 300 Hz to 3400 Hz, so the white noise should preferably cover or block the entire voice spectrum of 300 Hz to 3400 Hz. While the white noise signal is generated by the microcontroller, the ALPD of embodiments of the invention does not contain a digital-to-analog converter (DAC) in any conventional sense. For producing white noise, generally the main criterion is that each audio sample is uncorrelated with the previous sample. The sample resolution typically does not matter, so the ALPD of embodiments of the invention uses 1-bit audio samples. That is, each sample of the audio stream is either a 0 or a 1. So a single digital output pin from the microcontroller 70 is all that is needed to provide an audio signal for the amplifier 74. The microcontroller 70 of the ALPD of embodiments of the invention uses a structure called a linear-feedback shift register (LFSR), which is an economical way to produce pseudorandom numbers for this type of platform. Every 25 μs the LFSR generates a new random 1-bit sample, equating to a sample frequency of 40 kHz. This means the signal can contain audio content up to 20 kHz (i.e., 40 kHz/2, per the Nyquist Theorem). The lower bound is determined by the period of the pseudorandom number generator, but is around 1 Hz. The actual audio output for a system like this is typically going to be determined more by the frequency characteristics of the speaker than by the audio signal. The LFSR operates in a 16-bit maximal length configuration, which means the random number generator is periodic. One way to think of this is that it is playing the same ˜1.6 second (25 μs×2̂16=1.6384 s) “clip” of white noise over and over again.

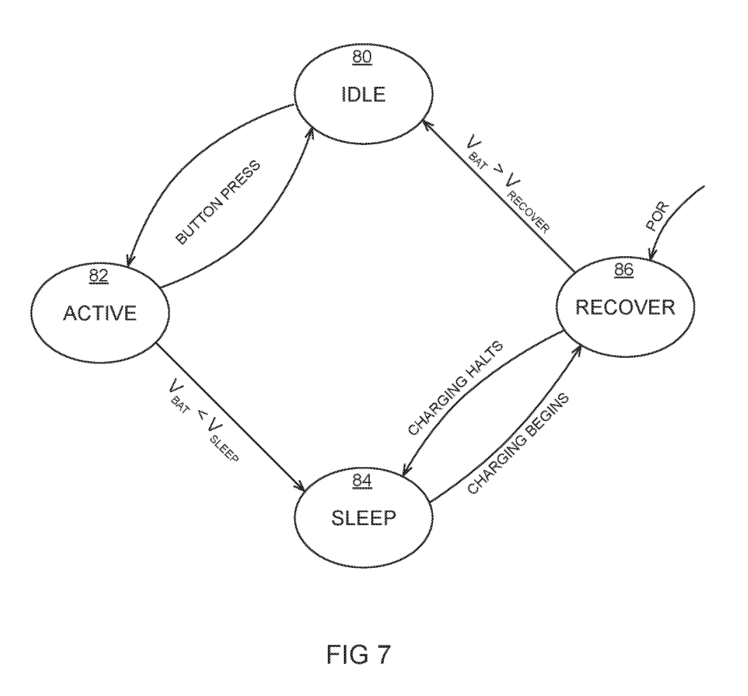

FIG. 7 is a state diagram of an active listening privacy device of embodiments of the invention. In the illustrated embodiment, the ALPD has four states: IDLE 80, ACTIVE 82, SLEEP 84, and RECOVER 86. Most of the functional life of the ALPD is spent in the IDLE and ACTIVE states. The other states exist for battery management. When in the IDLE state, the ALPD is not producing white noise but is ready to do so if activated. When in the ACTIVE state, the ALPD is producing white noise. White noise is only produced during the ACTIVE state. The ALPD transitions between the IDLE and ACTIVE states, for example, when a user presses the power button 16, although other alternative means may be used to cause the ALPD to transition between the IDLE and ACTIVE states (described further below).

If the battery voltage (V_{BAT}) is less than a predefined sleep voltage threshold (V_{SLEEP}), the ALPD will transition to the SLEEP state. The SLEEP state is ultra-low-power and unresponsive to the user interface. When in the SLEEP state, the ALPD appears to a user as “dead,” but actually the system is still running and aware and waiting for a charging cable to be plugged in. The device can remain in this SLEEP state for a long time before the battery actually dies.

When a charging cable is plugged in and charging begins, the ALPD transitions from the SLEEP state to the RECOVER state. If charging halts before V_{BAT} has recharged to a predefined recover voltage threshold (V_{RECOVER}), then the ALPD transitions from the RECOVER state to the SLEEP state. When V_{BAT} is greater than V_{RECOVER,} the ALPD transitions from the RECOVER state to the IDLE state. In one embodiment of the invention, V_{RECOVER}>V_{SLEEP}>3.0V, and V_{RECOVER}=3.3V and V_{SLEEP}=3.1V, although these values may vary.

When a “Power-on Reset” (POR) occurs (i.e., where the system starts running code immediately after being turned on or after a system reset), the device begins in the RECOVER state. The device may or may not immediately transition to either the IDLE state or the SLEEP state, depending on the value of V_{BAT} and whether the device is connected to a charger.

The status indicator LED 20 may have a plurality of different states (e.g., on, off, flashing) and/or a plurality of different colors (e.g., red, green). The behavior of the status indicator LED 20 may be a function of battery voltage, charging status, and/or system state, etc.

A user may be able to control an ALPD of embodiments of the invention using one or more of several possible options. In one option, an ALPD may be operated manually by a user activating one or more buttons, switches, etc. For example, a user may cause the ALPD to switch between the IDLE and ACTIVE states by pressing the power button 16.

In another option, an ALPD may be controlled via a software application (“app”) that a user downloads and installs on a mobile device. Such an app may allow a user to add and control multiple ALPD devices and input a name for each as it is paired with a particular ALD that is being controlled. A user may be able to adjust the volume on each of the ALPDs via the app. A user may be able to cause the ALPD to switch between the IDLE and ACTIVE states via the app. The ALPD may be able to communicate with other devices (e.g., other ALPD's, control devices such as mobile devices (cell phone, tablet, etc.) and PCs) using any suitable communication technology, including but not limited to Bluetooth, Wi-Fi, cellular telephony, etc.

In yet another option, a wireless remote control may be used to control the ALPD. Such a wireless remote control may communicate with the ALPD via, for example, radio frequency (RF) or infrared (IR) signals. Such a wireless remote control may allow a user to add and control multiple ALPD devices and input a name for each as it is paired with a particular ALD that is being controlled. A user may be able to adjust the volume on each of the ALPDs via the remote control. A user may be able to cause the ALPD to switch between the IDLE and ACTIVE states via the remote control.

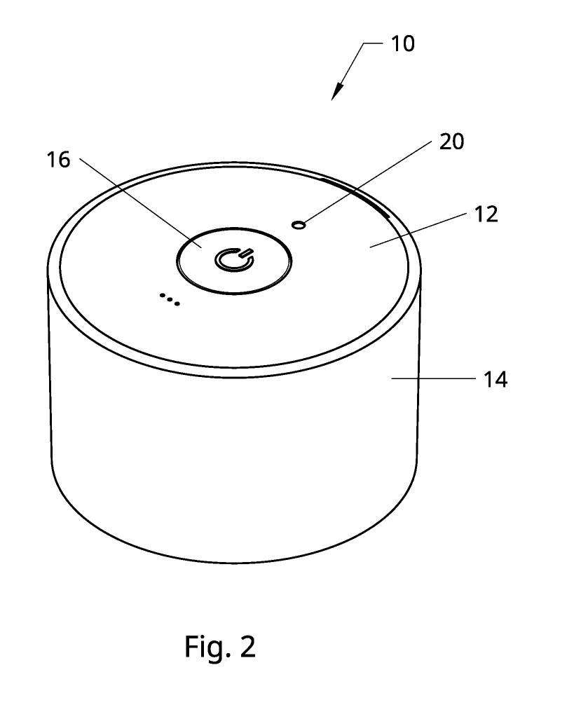

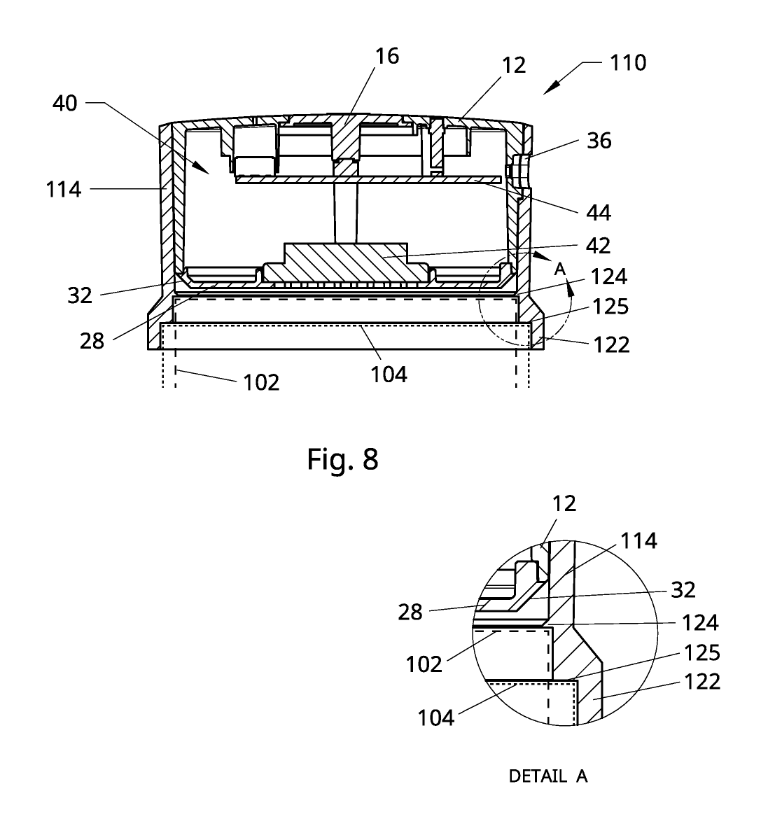

FIG. 8 illustrates an embodiment of the invention in which an ALPD is able to engage with two different size ALDs at different times by having two shelves or shoulders, each shelf or shoulder having a different size (e.g., diameter). FIG. 8 illustrates an ALPD 110 in accordance with alternative embodiments of the invention. The ALPD 110 is similar to the ALPD 10 of FIGS. 2-5 (the inner “puck” portion is identical) but with a different outer housing portion 114 mated to the inner housing portion 12. (Alternatively, the housing of the ALPD may comprise a single, unitary housing forming the side wall, top wall, chamber, and collar.) As seen in FIG. 8, the collar 122 has a first shelf/shoulder 124 closer to the speaker 42 and a second shelf/shoulder 125 further from the speaker (i.e., between the first shelf/shoulder 124 and the open end. The second shelf/shoulder 125 is larger (e.g., has a larger diameter if cylindrical) than the first shelf/shoulder 124. The size of each shelf/shoulder corresponds to a different sized ALD. As seen in FIG. 8, the first shelf/shoulder 124 can engage a first ALD (illustrated by dashed line 102) and the second shelf/shoulder 125 can engage a second ALD (illustrated by dotted line 104) that is larger than the first ALD. In this regard, the same ALPD can be used with different ALDs having different diameters at different times.

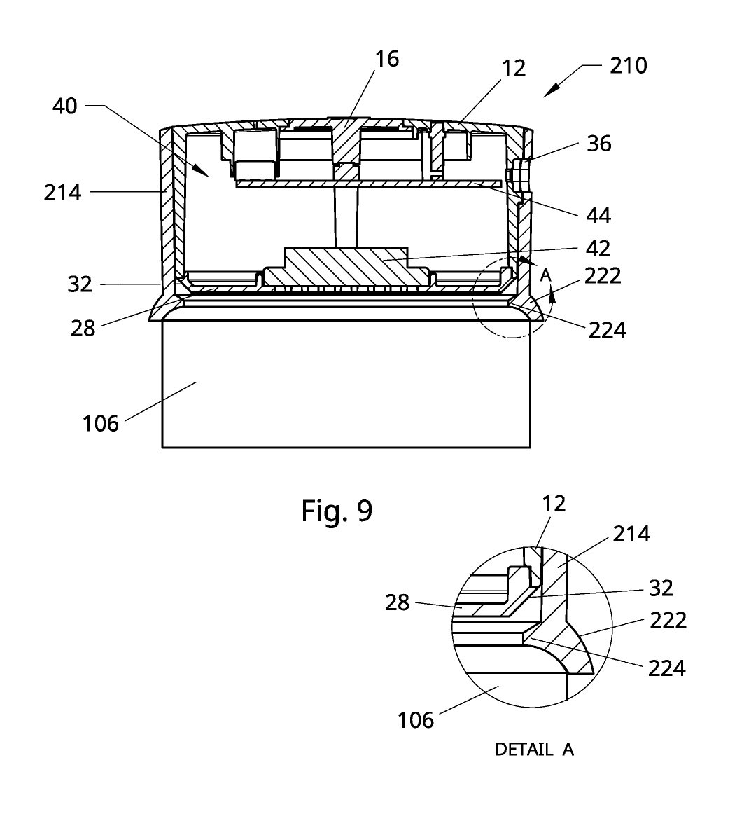

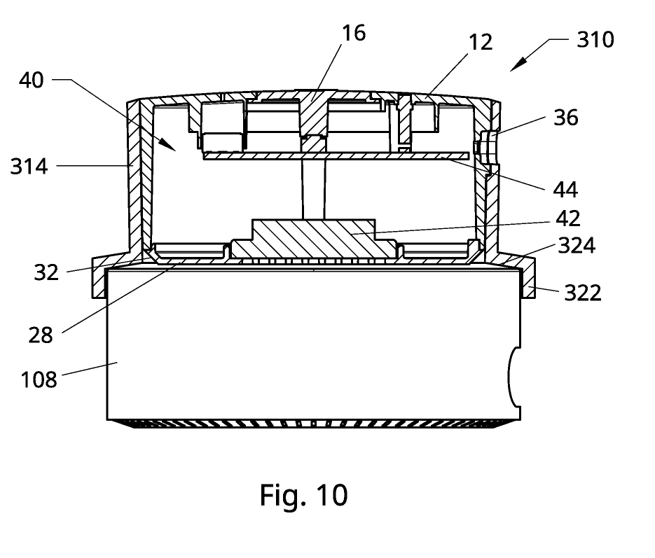

FIGS. 9 and 10 illustrate the benefit of a two-part housing. The benefit of a two-part housing, as illustrated, lies in the ability to modify an ALPD to interface with different types of ALDs. The same inner housing portion, speaker, speaker cover, and internal components (within the chamber) may be used across many different types of ALDs (these common components may be termed the “puck” as they are collectively shaped like a hockey puck in the illustrated embodiments). Different outer housing portions may be selectively, interchangeably mated with the same puck (typically by the manufacturer, but possibly by a consumer). The different outer housing portions may have a collar and open end that is differently sized (such as having a different diameter if circular) and/or differently shaped (e.g., circular, oval, square, etc.) to correspond with different size and/or shape ALDs.

FIG. 9 illustrates an ALPD 210 in accordance with alternative embodiments of the invention. The ALPD 210 is similar to the ALPD 10 of FIGS. 2-5 (the “puck” is identical) but with a different outer housing portion 214 mated to the inner housing portion 12. As seen in FIG. 9, the collar 222 and the shelf/shoulder 224 have a different, curved shape to accommodate an ALD 106 that has a corresponding curved top surface.

FIG. 10 illustrates an ALPD 310 in accordance with alternative embodiments of the invention. The ALPD 310 is similar to the ALPD 10 of FIGS. 2-5 (the “puck” is identical) but with a different outer housing portion 314 mated to the inner housing portion 12. As seen in FIG. 10, the collar 322 and the shelf/shoulder 324 are flared outward to accommodate a larger ALD 108.

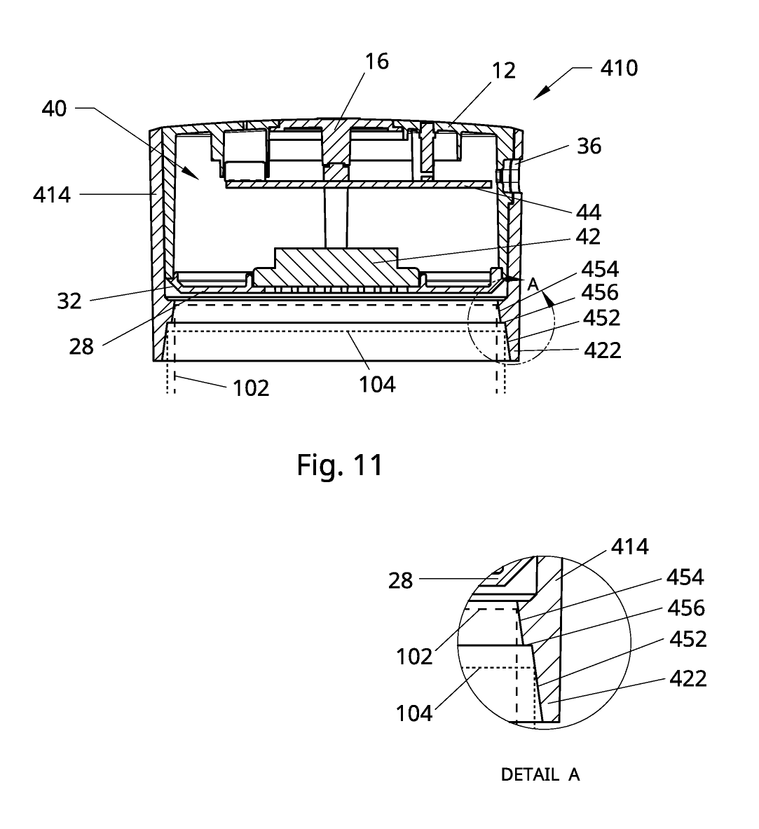

FIG. 11 illustrates an ALPD 410 in accordance with alternative embodiments of the present invention. The ALPD 410 is similar to the ALPD 110 of FIG. 8 (the “puck” is identical) but with a different outer housing portion 414 mated to the inner housing portion 12. (Alternatively, the housing of the ALPD may comprise a single, unitary housing forming the side wall, top wall, chamber, and collar.) As seen in FIG. 11, the collar 422 advantageously has an inner surface that is sloped or angled outward toward the open end. The ALPD 410 of FIG. 11 actually has two different angled surfaces—a proximal angled surface 454 that is closer to the speaker 42 and a distal angled surface 452 that is closer to the open end. The distal angled surface 452 has a larger diameter than the proximal angled surface 454, such that a shoulder 456 is formed therebetween. The diameter of each angled surface is selected to generally correspond to a different sized ALD. As seen in FIG. 11, the proximal angled surface 454 can engage a first ALD (illustrated by dashed line 102) and the distal angled surface 452 can engage a second ALD (illustrated by dotted line 104) that is larger than the first ALD. In this regard, the same ALPD can be used with different ALDs having different diameters at different times. Further, the use of angled surfaces enables the ALPD 410 to readily accommodate minor variations in the size of the ALD that the ALPD is designed to accept. As an example, the diameter of the proximal angled surface 454 may be selected to accept a specific model of ALD that has a specific nominal diameter. However, the actual ALD as manufactured and sold may have a diameter that varies slightly from the nominal diameter due to manufacturing tolerances, etc. If the actual ALD diameter is slightly larger than the nominal ALD diameter, then the ALD will contact the angled surface closer to the open end but will still have the desired contact between the ALD and the ALPD to provide the desired masking. Conversely, if the actual ALD diameter is slightly smaller than the nominal ALD diameter, then the ALD will contact the angled surface closer to the speaker but will still have the desired contact between the ALD and the ALPD to provide the desired masking. The diameter and angle of each angled surface will typically be selected such that an ALD having the nominal diameter will contact at or near the middle of the corresponding angled surface, such that both larger and smaller varying diameters can be accommodated (within the design limits).

Since the ALPD 410 of FIG. 11 has two angled surfaces 452, 454, the ALPD 410 is designed to accommodate two different ALD models with two different nominal diameters. In alternative embodiments of the invention, a single angled surface may be used. The specific angle of the angled surface(s) may vary. As the angle of the angled surface increases (i.e., further from vertical), the ALPD can accommodate a greater variation in ALD diameter.

In the embodiment of FIG. 11, the angled surface(s) are formed by the collar 422 which is part of the outer housing portion 414 (or, in the alternative embodiment mentioned above, the angled surface(s) are formed by the single, unitary housing forming the side wall, top wall, chamber, and collar). Thus, the angled surface(s) of the embodiment of FIG. 11 is/are constructed of the same rigid, durable material as the housing.

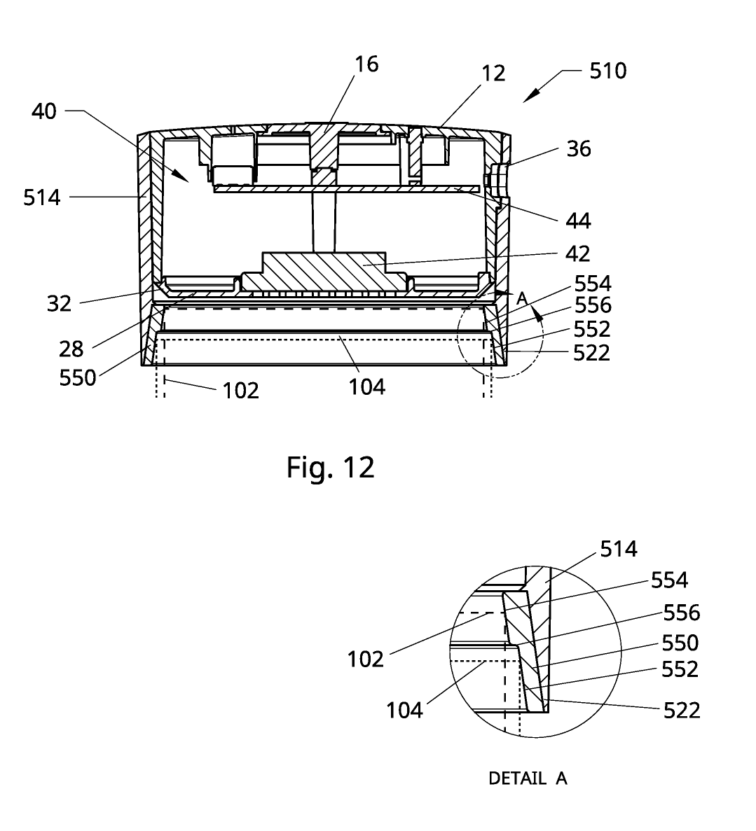

FIG. 12 illustrates an ALPD 510 in accordance with alternative embodiments of the present invention. The ALPD 510 is similar to the ALPD 110 of FIG. 8 (the “puck” is identical) but with a different outer housing portion 514 mated to the inner housing portion 12. (Alternatively, the housing of the ALPD may comprise a single, unitary housing forming the side wall, top wall, chamber, and collar.) As seen in FIG. 12 and similar to the ALPD 410 of FIG. 11, two different angled surfaces are formed within the collar 522—a proximal angled surface 554 that is closer to the speaker 42 and a distal angled surface 552 that is closer to the open end. The distal angled surface 552 has a larger diameter than the proximal angled surface 554, such that a shoulder 556 is formed therebetween. The diameter of each angled surface is selected to generally correspond to a different sized ALD. As seen in FIG. 12 and similar to the ALPD 410 of FIG. 11, the proximal angled surface 554 can engage a first ALD (illustrated by dashed line 102) and the distal angled surface 552 can engage a second ALD (illustrated by dotted line 104) that is larger than the first ALD. In this regard, the same ALPD can be used with different ALDs having different diameters at different times. Further, the use of angled surfaces enables the ALPD 510 to readily accommodate minor variations in the size of the ALD that the ALPD is designed to accept.

Unlike the embodiment of FIG. 11, the angled surface(s) of the ALPD 510 of FIG. 12 are formed by an elastomeric insert or adapter 550 that is affixed to the inside surface of the collar 522. The compressible nature of the elastomeric adapter 550 enables the ALPD to accept a somewhat wider variation of sizes of ALD, as well as enabling the ALD to be more snugly mated to the ALPD to help retain the ALPD on top of the ALD. The elastomeric adapter 550 may be constructed of any suitable durable material having the desired amount of compressibility, such as a 40 durometer translucent thermoplastic elastomer or silicone.

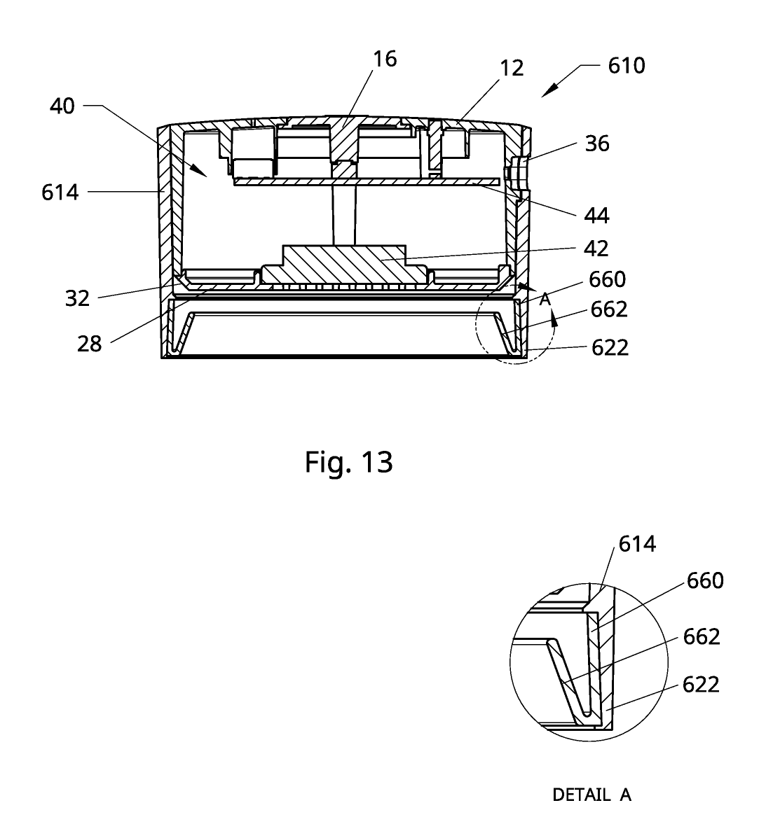

Embodiments of the invention may comprise an elastomeric projection on the inside surface of the collar. The compressible nature of such an elastomeric projection enables the ALPD to accept a variation of sizes of ALD, as well as enabling the ALD to be more snugly mated to the ALPD to help retain the ALPD on top of the ALD. One type of elastomeric projection is illustrated in FIG. 13. FIG. 13 illustrates an ALPD 610 in accordance with alternative embodiments of the invention. The ALPD 610 is similar to the ALPD 10 of FIGS. 2-5 (the inner “puck” portion is identical) but with a different outer housing portion 614 mated to the inner housing portion 12. (Alternatively, the housing of the ALPD may comprise a single, unitary housing forming the side wall, top wall, chamber, and collar.) As seen in FIG. 8, a wiping seal is affixed to the inside surface of the collar 622. The wiping seal comprises a base or fixed portion 660, by which the wiping seal is affixed to the collar 622, and a movable blade portion 662. The blade portion 662 projects inward at an angle toward the speaker. The blade portion 662 is stretched outward as an ALD is inserted into the open end, thereby enabling the ALD to be more snugly mated to the ALPD to help retain the ALPD on top of the ALD. The wiping seal 660, 662 may be constructed of any suitable durable material having the desired amount of flexibility, such as a 40 durometer translucent thermoplastic elastomer or silicone.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A sound masking device comprising:
a housing having an open end;
a white noise generator within the housing; and
a speaker to receive a white noise signal from the white noise generator and to emit a white noise corresponding to the white noise signal, the speaker being set back from the open end and positioned within the housing to emit the white noise toward the open end.

2. The device of claim 1, wherein the open end is adapted to receive an upper portion of an active listening device such that the upper portion of the active listening device contacts an inner surface of the housing located between the speaker and the open end to create a closed acoustical chamber between the upper portion of the active listening device and the speaker.

3. The device of claim 1, wherein the open end is adapted to receive an upper portion of an active listening device such that the upper portion of the active listening device contacts an inner surface of the housing located between the speaker and the open end to block the white noise from escaping between the upper portion of the active listening device and the inner surface of the housing located between the speaker and the open end.

4. The device of claim 1, wherein an inner surface of the housing located between the speaker and the open end comprises a first angled portion that is angled outward toward the open end.

5. The device of claim 4, wherein the inner surface of the housing located between the speaker and the open end further comprises a second angled portion that is angled toward the open end; and
wherein a diameter of the first angled portion is smaller than a diameter of the second angled portion.

6. The device of claim 1, wherein at least a portion of an inner surface of the housing located between the speaker and the open end has an elastomeric surface or an elastomeric projection therefrom.

7. The device of claim 6, wherein the elastomeric projection comprises a wiping seal.

8. The device of claim 1, wherein the housing comprises a shelf or shoulder around an inner surface of the housing located between the speaker and the open end.

9. The device of claim 8, wherein the shelf or shoulder is a first shelf or shoulder having a diameter;
wherein the housing further comprises a second shelf or shoulder around the inner surface of the housing located between the first shelf or shoulder and the open end, the second shelf or shoulder having a diameter; and
wherein the diameter of the first shelf or shoulder is smaller than the diameter of the second shelf or shoulder.

10. The device of claim 1, wherein the housing comprises an inner housing portion and an outer housing portion;
wherein the outer housing portion forms a sleeve around the inner housing portion;
wherein the outer housing portion forms a collar extending beyond an end of the inner housing portion;
wherein the collar defines the open end of the housing; and
wherein the speaker is within or affixed to the inner housing portion.

11. The device of claim 10, wherein the outer housing portion comprises a shelf or shoulder around an inner surface of the collar.

12. The device of claim 10, wherein the outer housing portion is a first outer housing portion;
wherein the device further comprises a second outer housing portion;
wherein the first and second outer housing portions are selectively interchangeably attachable to the inner housing portion; and
wherein, when the second outer housing portion is attached to the inner housing portion, the second outer housing portion (a) forms a sleeve around the inner housing portion, (b) forms a collar extending beyond an end of the inner housing portion, and(c) defines an open end of the housing.

13. The device of claim 12, wherein the collar formed by the first outer housing portion has a different size than the collar formed by the second outer housing portion.

14. The device of claim 12, wherein the collar formed by the first outer housing portion has a different diameter than the collar formed by the second outer housing portion.

15. The device of claim 12, wherein the collar formed by the first outer housing portion has a different shape than the collar formed by the second outer housing portion.

16. A method of masking sound reaching a microphone of an active listening device, the method comprising:
positioning a sound masking device on an active listening device such that a portion of the active listening device containing one or more microphones is inserted into an open end of a housing of the sound masking device; and
activating the sound masking device such that a speaker within the housing of the sound masking device emits white noise toward the open end of the housing of the sound masking device and toward the portion of the active listening device containing one or more microphones.

17. The method of claim 16, wherein the inserted portion of the active listening device contacts an inner surface of the housing located between the speaker and the open end to create a closed acoustical chamber between the inserted portion of the active listening device and the speaker.

18. The method of claim 16, wherein the inserted portion of the active listening device contacts an inner surface of the housing located between the speaker and the open end to block the white noise from escaping between the inserted portion of the active listening device and the inner surface of the housing located between the speaker and the open end.

19. The method of claim 16, wherein an inner surface of the housing located between the speaker and the open end comprises a first angled portion that is angled outward toward the open end.

20. The method of claim 19, wherein the inner surface of the housing located between the speaker and the open end further comprises a second angled portion that is angled toward the open end; and
wherein a diameter of the first angled portion is smaller than a diameter of the second angled portion.

21. The method of claim 16, wherein at least a portion of an inner surface of the housing located between the speaker and the open end has an elastomeric surface or an elastomeric projection therefrom.

22. The method of claim 21, wherein the elastomeric projection comprises a wiping seal.

23. The method of claim 16, wherein the housing of the sound masking device comprises a shelf or shoulder around an inner surface of the housing located between the speaker and the open end; and
wherein a portion of the active listening device contacts the shelf or shoulder when the sound masking device is positioned on the active listening device.

24. The method of claim 23, wherein the shelf or shoulder is a first shelf or shoulder having a diameter;
wherein the housing further comprises a second shelf or shoulder around an inner surface of the housing located between the first shelf or shoulder and the open end, the second shelf or shoulder having a diameter;
wherein the diameter of the first shelf or shoulder is smaller than the diameter of the second shelf or shoulder; and
wherein, depending on a size of the portion of the active listening device containing one or more microphones, a portion of the active listening device contacts either the first shelf or shoulder or the second shelf or shoulder when the sound masking device is positioned on the active listening device.

25. The method of claim 16, wherein the housing comprises an inner housing portion and an outer housing portion;
wherein the outer housing portion forms a sleeve around the inner housing portion;
wherein the outer housing portion forms a collar extending beyond an end of the inner housing portion;
wherein the collar defines the open end of the housing; and
wherein the speaker is within or affixed to the inner housing portion.

26. The method of claim 25, wherein the outer housing portion comprises a shelf or shoulder around an inner surface of the collar.

27. The method of claim 25, wherein the outer housing portion is a first outer housing portion;
wherein the device further comprises a second outer housing portion;
wherein the first and second outer housing portions are selectively interchangeably attachable to the inner housing portion;
wherein, when the second outer housing portion is attached to the inner housing portion, the second outer housing portion (a) forms a sleeve around the inner housing portion, (b) forms a collar extending beyond an end of the inner housing portion, and(c) defines an open end of the housing; and
wherein the method further comprises selecting one of the first or second outer housing portion corresponding to a physical characteristic of the active listening device and attaching the selected outer housing portion to the inner housing portion.

28. The method of claim 27, wherein the collar formed by the first outer housing portion has a different size than the collar formed by the second outer housing portion; and
wherein the physical characteristic of the active listening device comprises a size of the portion of the active listening device containing one or more microphones.

29. The method of claim 27, wherein the collar formed by the first outer housing portion has a different diameter than the collar formed by the second outer housing portion; and
wherein the physical characteristic of the active listening device comprises a diameter of the portion of the active listening device containing one or more microphones.

30. The method of claim 27, wherein the collar formed by the first outer housing portion has a different shape than the collar formed by the second outer housing portion; and
wherein the physical characteristic of the active listening device comprises a shape of the portion of the active listening device containing one or more microphones.
